(19) United States
(12) Patent Application Publication
(10) Pub. No.: US 2021/0044002 A1
(43) Pub. Date: Feb. 11, 2021

(54) ELECTRONIC DEVICE INCLUDING MULTIPLE ANTENNA MODULES

(71) Applicant: Samsung Electronics Co., Ltd., Suwon-si (KR)

(72) Inventors: Haekwon LEE, Suwon-si (KR); Yeonwoo KIM, Suwon-si (KR); Soon PARK, Suwon-si (KR); Woosup LEE, Suwon-si (KR); Hyoseok NA, Suwon-si (KR)

(21) Appl. No.: 16/947,546

(22) Filed: Aug. 6, 2020

(30) Foreign Application Priority Data
Aug. 6, 2019 (KR) 10-2019-0095693

(51) Int. Cl. H01Q 1/24; H01Q 21/06; H01Q 3/34

(52) U.S. Cl. CPC H01Q 1/243; H01Q 3/34; H01Q 21/065

(57) ABSTRACT

An electronic device includes a housing including a front surface, a back surface, and a side surface; a first antenna module disposed adjacent to at least a surface of the housing, facing in a direction, outside of the housing, and operated in a transmission mode for transmitting a signal to an external electronic device or in a reception mode for receiving a signal from the external electronic device; and a second antenna module disposed apart from the first antenna module, facing in a direction different from the direction of the first antenna module, operated in a reception mode for receiving a signal when the first antenna module is operated in the transmission mode, and operated in a transmission mode for transmitting a signal when the first antenna module is operated in the reception mode.

### CROSS-REFERENCE TO RELATED APPLICATION

This application is based on and claims priority under 35 U.S.C. 119 to Korean Patent Application No. 10-2019-0095693, filed on Aug. 6, 2019, in the Korean Intellectual Property Office, the disclosure of which is herein incorporated by reference in its entirety.

### BACKGROUND

### 1. Field

Various embodiments of the disclosure relate to an electronic device including a plurality of antenna modules.

### 2. Description of Related Art

To provide a stable quality of service over a commercial wireless communication network, an electronic device needs to meet a high gain and broad beam coverage of antenna modules. A next-generation mobile communication service (e.g., 5G communication) with a frequency band of a few tens of GHz (e.g., a frequency band ranging from 20 GHz to 300 GHz and a frequency wavelength ranging about 1 mm to about 10 mm) implements easy connection (e.g., wireless linkage) with nearby electronic devices and enhanced energy efficiency, thereby providing enhanced connection expandability and quicker and more stable quality of wireless communication networks to users.

Recently, wireless gigabit (WiGig), as an ultra-high rate short-range wireless communication standard, is under development. WiGig is technology of providing 10 times higher, or more, transmission speed as compared with conventional Wi-Fi in the Wi-Fi band (2.4/5 GHz) and 60 GHz band and is optimized for inter-device short-range transmission for digital video services.

Antenna modules are optimized for their operation properties by various simulations and may then be manufactured. In practice, however, the operation properties of an antenna module may be distorted when the antenna module is mounted on an electronic device despite optimization. In other words, the operation properties of the antenna module may be varied depending on the mounting environment of the antenna module or the specifications of the electronic device.

Since the frequency wavelength of the antenna module used for 5G communication (or mmWave communication) merely ranges from about 1 mm to about 10 mm, the radiation performance of the antenna module may be significantly distorted depending on the installation environment due to its high straightness and directivity. For example, when an antenna module for mmWave communication is equipped in an electronic device, the performance of the antenna module may be lowered due to interference by the structures around the electronic device or the user's body. A plurality of antenna modules may be provided in an electronic device to support 5G communication. In this case, propagation loss may be caused by interference between the beams radiated from adjacent antenna modules, thus resulting in deterioration of radiation performance.

The above information is presented as background information only to assist with an understanding of the disclosure. No determination has been made, and no assertion is made, as to whether any of the above might be applicable as prior art with regard to the disclosure.

### SUMMARY

According to various embodiments, there may be provided a plurality of antenna modules capable of securing a stable radiation performance in a mmWave frequency band and an electronic device including the same.

According to various embodiments, there may be provided a plurality of antenna modules capable of providing a stable wireless communication function by preventing distortion of radiation performance due to interference by beams from adjacent antenna modules and an electronic device including the same.

In accordance with various embodiments, an electronic device comprises a housing including a front surface, a back surface facing away from the front surface, and a side surface disposed between the front surface and the back surface to form a space between the front surface and the back surface, a first antenna module disposed adjacent to at least a surface of the housing, facing in a direction, outside of the housing, and operated in a transmission mode for transmitting a signal to an external electronic device or in a reception mode for receiving a signal from the external electronic device, and a second antenna module disposed apart from the first antenna module, facing in a direction different from the direction of the first antenna module, operated in a reception mode for receiving a signal when the first antenna module is operated in the transmission mode, and operated in a transmission mode for transmitting a signal when the first antenna module is operated in the reception mode, wherein at least one of the first antenna module and the second antenna module includes a base unit including a dielectric material, a plurality of first conductive elements arranged on a first surface of the base unit, and a plurality of second conductive elements arranged on another surface facing away from the first surface of the base unit and corresponding to the plurality of first conductive elements.

In accordance with various embodiments, there is provided a method of operating an electronic device including a plurality of antenna modules, the electronic device including a first antenna module disposed adjacent to at least one surface of a housing of the electronic device and facing in a first direction, outside of the housing, a second antenna module disposed apart from the first antenna module and facing in a direction different from the first direction of the first antenna module, at least one first conductive line connected with the first antenna module, and at least one second conductive line connected with the second antenna module, wherein at least one of the first antenna module and the second antenna module includes a base unit including a dielectric material, a plurality of first conductive elements arranged on a first surface of the base unit, a plurality of second conductive elements arranged on a second surface of the base unit, which face away from the first surface of the base unit, and corresponding to the plurality of first conductive elements, at least one processor, and a memory operatively connected with the processor, wherein at least one first signal line is included in one of the first conductive line or the second conductive line and connected with the first conductive elements, and at least one second signal line is connected with the second conductive elements, and wherein the processor is configured to, by instructions stored in the memory, apply a first frequency of signal to the first conductive elements via the at least one first signal line and apply a second frequency of signal with a phase difference of 180 degrees from the first frequency to the second conductive elements via the at least one second signal line.

Other aspects, advantages, and salient features of the disclosure will become apparent to those skilled in the art from the following detailed description, which, taken in conjunction with the annexed drawings, discloses example embodiments of the disclosure.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document. Those of ordinary skill in the art should understand that in many, if not most instances, such definitions apply to prior, as well as future uses of such defined words and phrases.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIG. 1 is a block diagram illustrating an electronic device in a network environment according to an embodiment;

FIG. 2 is a block diagram illustrating an electronic device in a network environment including a plurality of cellular networks according to an embodiment;

FIGS. 3A, 3B, 3C, and 3D are views illustrating a structure of an electronic device including antenna modules according to an embodiment;

FIGS. 4A, 4B, and 4C are views illustrating a structure of an antenna assembly according to an embodiment;

FIG. 5A is a view illustrating a range in which an antenna beam is radiated from an electronic device according to an embodiment;

FIG. 5B is a view illustrating a gain of a beam pattern when an antenna beam is radiated from an electronic device according to an embodiment;

FIG. 6 is a view illustrating an electronic device including a plurality of antenna modules according to an embodiment;

FIG. 7 is a view illustrating an electronic device including a plurality of antenna modules according to a first embodiment;

FIG. 8 is a view illustrating an electronic device including a plurality of antenna modules according to a second embodiment;

FIG. 9 is a perspective view illustrating an antenna module including a plurality of first conductive elements formed on one surface of a base unit and a plurality of second conductive elements formed on the opposite surface of the base unit according to an embodiment;

FIG. 10 is a cross-sectional view illustrating an antenna module including a plurality of first conductive elements formed on one surface of a base unit and a plurality of second conductive elements formed on the opposite surface of the base unit according to an embodiment;

FIG. 11 is a view illustrating circuit configurations applying a designated frequency of signal to a plurality of first conductive elements formed on one surface of a base unit and a plurality of second conductive elements formed on the opposite surface of the base unit according to an embodiment;

FIG. 12 is a perspective view illustrating an antenna module including a plurality of first conductive elements formed on one surface of a base unit and a plurality of second conductive elements formed on the opposite surface of the base unit according to another embodiment;

FIG. 13 is a cross-sectional view illustrating an antenna module including a plurality of first conductive elements formed on one surface of a base unit and a plurality of second conductive elements formed on the opposite surface of the base unit according to an embodiment;

FIG. 14 is a view illustrating circuit configurations applying a designated frequency of signal to a plurality of first conductive elements formed on one surface of a base unit and a plurality of second conductive elements formed on the opposite surface of the base unit according to an embodiment;

FIG. 15A is a view illustrating an antenna module including a plurality of antenna assemblies according to an embodiment;

FIG. 15B is a view illustrating an antenna module including a plurality of antenna assemblies as viewed in direction W of FIG. 15A, according to an embodiment;

FIG. 15C is a view illustrating an antenna module including a plurality of antenna assemblies as viewed in direction W of FIG. 15A, according to an embodiment different from that of FIG. 15B;

FIG. 16 is a view illustrating a gain of a first direction component of a beam pattern when an antenna beam is radiated from an electronic device according to an embodiment;

FIG. 17 is a view illustrating a gain of a second direction component of a beam pattern when an antenna beam is radiated from an electronic device according to an embodiment; and

FIG. 18 is a view illustrating variations in gain of a beam pattern when an antenna beam is radiated from an electronic device, according to an embodiment.

Throughout the drawings, like reference numerals will be understood to refer to like parts, components, and structures.

### DETAILED DESCRIPTION

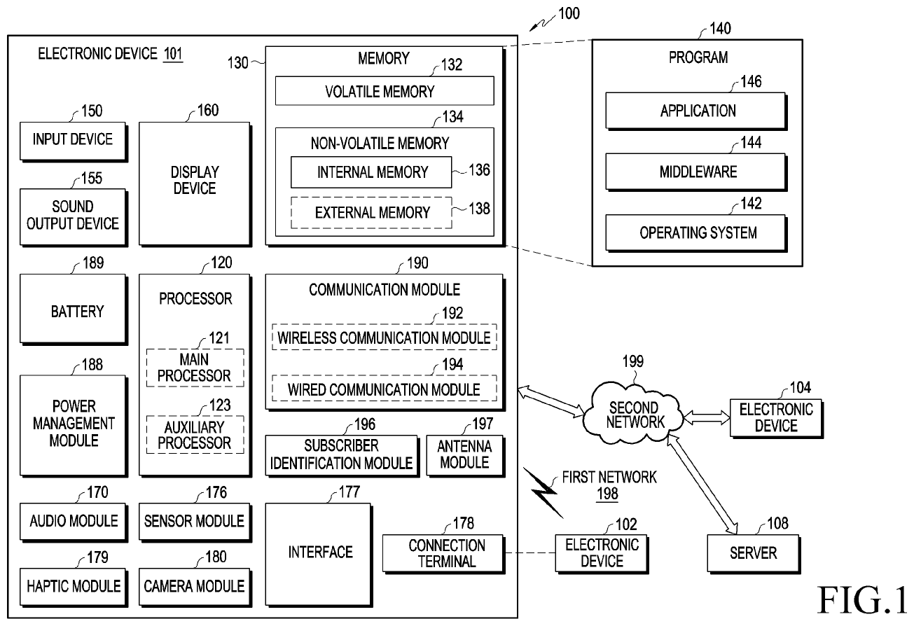

FIGS. 1 through 18, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure are described with reference to the accompanying drawings.

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input device 150, a sound output device 155, a display device 160, an audio module 170, a sensor module 176, an interface 177, a haptic module 179, a camera module 180, a power management module 188, a battery 189, a communication module 190, a subscriber identification module (SIM) 196, or an antenna module 197. In some embodiments, at least one (e.g., the display device 160 or the camera module 180) of the components may be omitted from the electronic device 101, or one or more other components may be added in the electronic device 101. In some embodiments, some of the components may be implemented as single integrated circuitry. For example, the sensor module 176 (e.g., a fingerprint sensor, an iris sensor, or an illuminance sensor) may be implemented as embedded in the display device 160 (e.g., a display).

The processor 120 may execute, e.g., software (e.g., a program 140) to control at least one other component (e.g., a hardware or software component) of the electronic device 101 connected with the processor 120 and may process or compute various data. According to one embodiment, as at least part of the data processing or computation, the processor 120 may load a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), and an auxiliary processor 123 (e.g., a graphics processing unit (GPU), an image signal processor (ISP), a sensor hub processor, or a communication processor (CP)) that is operable independently from, or in conjunction with, the main processor 121. Additionally or alternatively, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one (e.g., the display device 160, the sensor module 176, or the communication module 190) of the components of the electronic device 101, instead of the main processor 121 while the main processor 121 is in an inactive (e.g., sleep) state or along with the main processor 121 while the main processor 121 is an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input device 150 may receive a command or data to be used by other component (e.g., the processor 120) of the electronic device 101, from the outside (e.g., a user) of the electronic device 101. The input device 150 may include, for example, a microphone, a mouse, or a keyboard.

The sound output device 155 may output sound signals to the outside of the electronic device 101. The sound output device 155 may include, for example, a speaker or a receiver. The speaker may be used for general purposes, such as playing multimedia or playing record, and the receiver may be used for an incoming calls. According to an embodiment, the receiver may be implemented as separate from, or as part of the speaker.

The display device 160 may visually provide information to the outside (e.g., a user) of the electronic device 101. The display device 160 may include, for example, a display, a hologram device, or a projector and control circuitry to control a corresponding one of the display, hologram device, and projector. According to an embodiment, the display device 160 may include touch circuitry adapted to detect a touch, or sensor circuitry (e.g., a pressure sensor) adapted to measure the intensity of force incurred by the touch.

The audio module 170 may convert a sound into an electrical signal and vice versa. According to an embodiment, the audio module 170 may obtain a sound through the input device 150 or output a sound through the sound output device 155 or an external electronic device (e.g., an electronic device 102 (e.g., a speaker or a headphone) directly or wirelessly connected with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 02) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or wireless communication channel between the electronic device 101 and an external electronic device (e.g., the electronic device 102, the electronic device 104, or the server 108) and performing communication through the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a cellular network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The antenna module 197 may transmit or receive a signal or power to or from the outside (e.g., the external electronic device) of the electronic device 101. According to an embodiment, the antenna module may include one antenna including a radiator formed of a conductor or conductive pattern formed on a substrate (e.g., a printed circuit board (PCB)). According to an embodiment, the antenna module 197 may include one or more antennas, and, therefrom, at least one antenna appropriate for a communication scheme used in the communication network, such as the first network 198 or the second network 199, may be selected, for example, by the communication module 190 (e.g., the wireless communication module 192). The signal or the power may then be transmitted or received between the communication module 190 and the external electronic device via the selected at least one antenna.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. The first and second external electronic devices 102 and 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, or client-server computing technology may be used, for example.

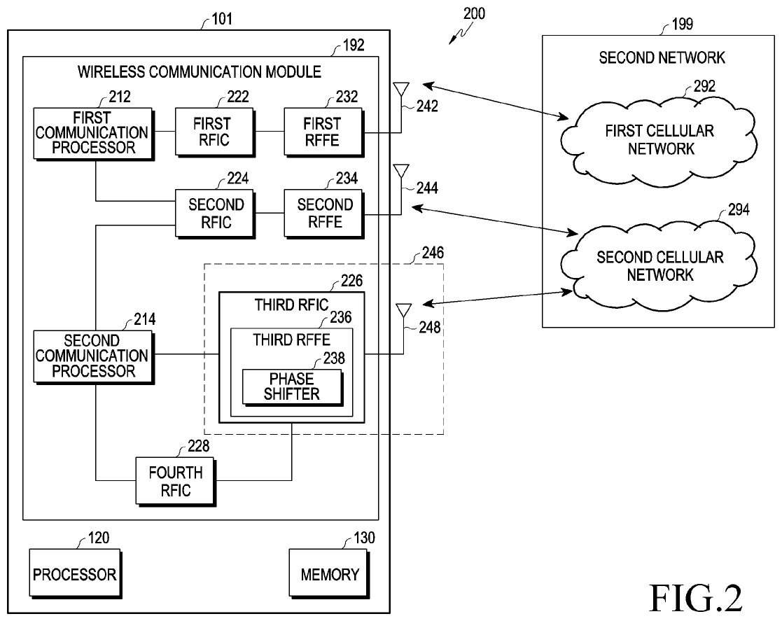

FIG. 2 is a block diagram 200 of an electronic device 101 in a network environment including a plurality of cellular networks according to an embodiment. Referring to FIG. 2, the electronic device 101 may include a first communication processor (CP) 212, a second CP 214, a first radio frequency integrated circuit (RFIC) 222, a second RFIC 224, a third RFIC 226, a fourth RFIC 228, a first radio frequency front end (RFFE) 232, a second RFFE 234, a first antenna module 242, a second antenna module 244, and an antenna 248. The electronic device 101 may further include a processor 120 and a memory 130. The second network 199 may include a first cellular network 292 and a second cellular network 294. According to an embodiment, the electronic device 101 may further include at least one component among the components of FIG. 1, and the second network 199 may further include at least one other network. According to an embodiment, the first communication processor (CP) 212, the second CP 214, the first RFIC 222, the second RFIC 224, the fourth RFIC 228, the first RFFE 232, and the second RFFE 234 may form at least part of the wireless communication module 192. According to an embodiment, the fourth RFIC 228 may be omitted or be included as part of the third RFIC 226.

The first CP 212 may establish a communication channel of a band that is to be used for wireless communication with the first cellular network 292 or may support legacy network communication via the established communication channel. According to an embodiment, the first cellular network may be a legacy network that includes second generation (2G), third generation (3G), fourth generation (4G), or long-term evolution (LTE) networks. The second CP 214 may establish a communication channel corresponding to a designated band (e.g., from about 6 GHz to about 60 GHz) among bands that are to be used for wireless communication with the second cellular network 294 or may support fifth generation (5G) network communication via the established communication channel. According to an embodiment, the second cellular network 294 may be a 5G network defined by the 3rd generation partnership project (3GPP). Additionally, according to an embodiment, the first CP 212 or the second CP 214 may establish a communication channel corresponding to another designated band (e.g., about 6 GHz or less) among the bands that are to be used for wireless communication with the second cellular network 294 or may support fifth generation (5G) network communication via the established communication channel. According to an embodiment, the first CP 212 and the second CP 214 may be implemented in a single chip or a single package. According to an embodiment, the first CP 212 or the second CP 214, along with the processor 120, an assistance processor 123, or communication module 190, may be formed in a single chip or single package.

Upon transmission, the first RFIC 222 may convert a baseband signal generated by the first CP 212 into a radio frequency (RF) signal with a frequency ranging from about 700 MHz to about 3 GHz which is used by the first cellular network 292 (e.g., a legacy network). Upon receipt, the RF signal may be obtained from the first cellular network 292 (e.g., a legacy network) through an antenna (e.g., the first antenna module 242) and be pre-processed via an RFFE (e.g., the first RFFE 232). The first RFIC 222 may convert the pre-processed RF signal into a baseband signal that may be processed by the first CP 212.

Upon transmission, the second RFIC 224 may convert the baseband signal generated by the first CP 212 or the second CP 214 into a Sub6-band (e.g., about 6 GHz or less) RF signal (hereinafter, “5G Sub6 RF signal”) that is used by the second cellular network 294 (e.g., a 5G network). Upon receipt, the 5G Sub6 RF signal may be obtained from the second cellular network 294 (e.g., a 5G network) through an antenna (e.g., the second antenna module 244) and be pre-processed via an RFFE (e.g., the second RFFE 234). The second RFIC 224 may convert the pre-processed 5G Sub6 RF signal into a baseband signal that may be processed by a corresponding processor of the first CP 212 and the second CP 214.

The third RFIC 226 may convert the baseband signal generated by the second CP 214 into a 5G Above6 band (e.g., from about 6 GHz to about 60 GHz) RF signal (hereinafter, “5G Above6 RF signal”) that is to be used by the second cellular network 294 (e.g., a 5G network). Upon receipt, the 5G Above6 RF signal may be obtained from the second cellular network 294 (e.g., a 5G network) through an antenna (e.g., the antenna 248) and be pre-processed via the third RFFE 236. The third RFIC 226 may convert the pre-processed 5G Above6 RF signal into a baseband signal that may be processed by the second CP 214. According to an embodiment, the third RFFE 236 may be formed as part of the third RFIC 226.

According to an embodiment, the electronic device 101 may include the fourth RFIC 228 separately from, or as at least part of, the third RFIC 226. In this case, the fourth RFIC 228 may convert the baseband signal generated by the second CP 214 into an intermediate frequency band (e.g., from about 9 GHz to about 11 GHz) RF signal (hereinafter, “IF signal”) and transfer the IF signal to the third RFIC 226. The third RFIC 226 may convert the IF signal into a 5G Above6 RF signal. Upon receipt, the 5G Above6 RF signal may be received from the second cellular network 294 (e.g., a 5G network) through an antenna (e.g., the antenna 248) and be converted into an IF signal by the third RFIC 226. The fourth RFIC 228 may convert the IF signal into a baseband signal that may be processed by the second CP 214.

According to an embodiment, the first RFIC 222 and the second RFIC 224 may be implemented as at least part of a single chip or single package. According to an embodiment, the first RFFE 232 and the second RFFE 234 may be implemented as at least part of a single chip or single package. According to an embodiment, at least one of the first antenna module 242 or the second antenna module 244 may be omitted or be combined with another antenna module to process multi-band RF signals.

According to an embodiment, the third RFIC 226 and the antenna 248 may be disposed on the same substrate to form the third antenna module 246. For example, the wireless communication module 192 or the processor 120 may be disposed on a first substrate (e.g., a main painted circuit board (PCB)). In this case, the third RFIC 226 and the antenna 248, respectively, may be disposed on one area (e.g., the bottom) and another (e.g., the top) of a second substrate (e.g., a sub PCB) which is provided separately from the first substrate, forming the third antenna module 246. Placing the third RFIC 226 and the antenna 248 on the same substrate may shorten the length of the transmission line therebetween. This may reduce a loss (e.g., attenuation) of a high-frequency band (e.g., from about 6 GHz to about 60 GHz) signal used for 5G network communication due to the transmission line. Thus, the electronic device 101 may enhance the communication quality with the second cellular network 294 (e.g., a 5G network).

According to an embodiment, the antenna 248 may be formed as an antenna array which includes a plurality of antenna elements available for beamforming. In this case, the third RFIC 226 may include a plurality of phase shifters 238 corresponding to the plurality of antenna elements, as part of the third RFFE 236. Upon transmission, the plurality of phase shifters 238 may change the phase of the 5G Above6 RF signal which is to be transmitted to the outside (e.g., a 5G network base station) of the electronic device 101 via their respective corresponding antenna elements. Upon receipt, the plurality of phase shifters 238 may change the phase of the 5G Above6 RF signal received from the outside to the same or substantially the same phase via their respective corresponding antenna elements. This enables transmission or reception via beamforming between the electronic device 101 and the outside.

The second cellular network 294 (e.g., a 5G network) may be operated independently (e.g., as standalone (SA)) from, or in connection (e.g., as non-standalone (NSA)) with the first cellular network 292 (e.g., a legacy network). For example, the 5G network may include access networks (e.g., 5G access networks (RANs)) but lack any core network (e.g., a next-generation core (NGC)). In this case, the electronic device 101, after accessing a 5G network access network, may access an external network (e.g., the Internet) under the control of the core network (e.g., the evolved packet core (EPC)) of the legacy network. Protocol information (e.g., LTE protocol information) for communication with the legacy network or protocol information (e.g., New Radio (NR) protocol information) for communication with the 5G network may be stored in the memory 130 and be accessed by other components (e.g., the processor 120, the first CP 212, or the second CP 214).

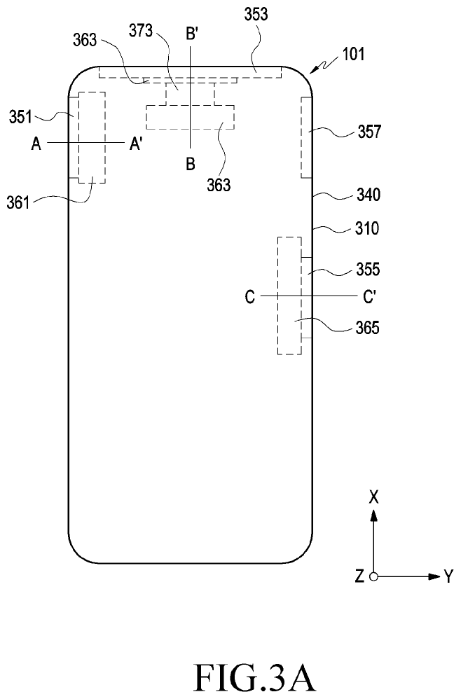

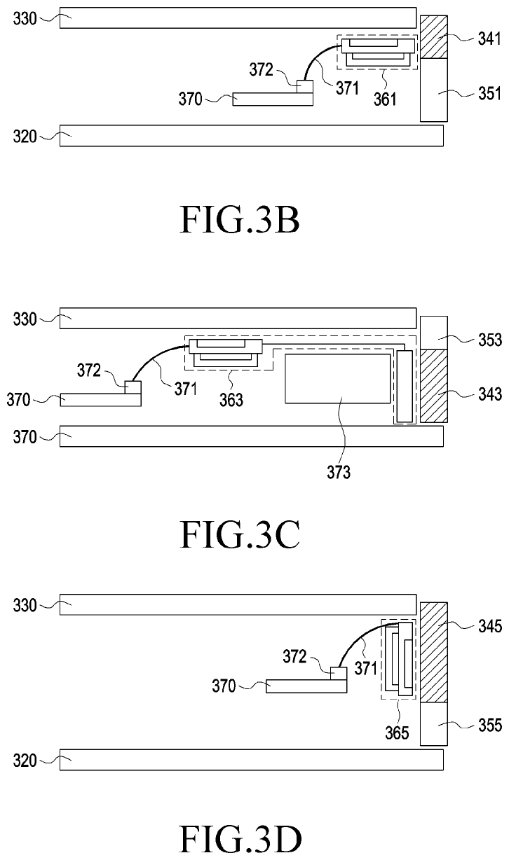

FIGS. 3A, 3B, 3C, and 3D are views illustrating a structure of an electronic device 101 including antenna modules 361, 363, and 365 according to an embodiment.

Referring to FIGS. 3A to 3D, an electronic device 101 may include a housing 310 that includes a first plate 320, a second plate 330 (e.g., a rear glass) spaced apart from the first plate 320 and facing away from the first plate 320, and a side surface member surrounding a space between the first plate 320 and the second plate 330.

According to an embodiment, the first plate 320 may include a transparent material including a glass plate. The second plate 330 may include a non-conductive and/or conductive material. The side surface member may include a conductive material and/or a non-conductive material. According to an embodiment, at least a portion of the side surface member may be integrally formed with the second plate 330. In the shown embodiment, the side surface member may include a first insulator to a third insulator 341, 343, and 345, and a first conductor to a third conductor 351, 353, and 355. According to an embodiment, the side surface member may further include a fourth conductor 357.

According to an embodiment, the electronic device 101 may include, in the space, a display disposed to be seen through the first plate 320, a main printed circuit board (PCB) 370, and/or a mid-plate (not shown). Optionally, the electronic device 101 may further include other various components.

According to an embodiment, the electronic device 101 may include, in the space and/or part (e.g., the side surface member) of the housing 310, a first legacy antenna 351, a second legacy antenna 353, and a third legacy antenna 355. The first to third legacy antennas 351 to 355 may be the first to third conductors 351 to 355 and used for, e.g., cellular communication (e.g., 2G, 3G, 4G, or LTE), short-range communication (e.g., Wi-Fi, Bluetooth, or NFC), and/or global navigation satellite system (GNSS).

According to an embodiment, the electronic device 101 may include a first antenna module 361, a second antenna module 363, and a third antenna module to form directional beams. The antenna modules 361, 363, and 365 may be used for 5G network (e.g., the second cellular network 294 of FIG. 2), mmWave communication, 60 GHz communication, or WiGig communication. The antenna modules 361, 363, and 365 may be disposed in the space to be spaced a predetermined interval or more apart from the metal members (e.g., the housing 310, the electric structure 373, and/or the first to third legacy antennas 351 to 355) of the electronic device 101.

According to an embodiment, the first antenna module 361 may be positioned at the left top (−Y axis), the second antenna module 363 may be positioned at the middle top (X axis), and the third antenna module 365 may be positioned at the right middle (Y axis). According to an embodiment, the electronic device 101 may include additional antenna modules in additional positions (e.g., the middle bottom (−Y axis)), or some of the first to third antenna modules 361 to 365 may be omitted. According to an embodiment, the first to third antenna modules 361, 363, and 365 may be electrically connected with at least one communication processor 372 (e.g., the processor 120 of FIG. 1) on the printed circuit board (PCB) 370 using a conductive line 371 (e.g., a coaxial cable or flexible printed circuit board (FPCB)).

Referring to FIG. 3B which is a cross-sectional view taken along line A-A′ of FIG. 3A, the antenna array of the first antenna module 361 may be disposed so that a portion (e.g., a patch antenna array) of the antenna array of the first antenna module 361 may emit radiation towards the second plate 330, and another portion (e.g., a dipole antenna array) thereof may emit radiation through the first insulator 341. Referring to FIG. 3C which is a cross-sectional view taken along line B-B′ of FIG. 3A, the antenna array of the second antenna module 363 may be disposed so that a portion (e.g., a patch antenna array) of the radiator of the second antenna module 363 may emit radiation towards the second plate 330, and another portion (e.g., a dipole antenna array) thereof may emit radiation through the second insulator 343.

According to an embodiment, the second antenna module 363 may include a plurality of printed circuit boards. For example, a part (e.g., a patch antenna array) and another (e.g., a dipole antenna array) of the antenna array may be positioned on different printed circuit boards. According to an embodiment, the printed circuit boards may be connected together via a flexible printed circuit board. The flexible printed circuit board may be disposed around an electric structure 373 (e.g., a receiver, speaker, sensor, camera, ear jack, or button).

Referring to FIG. 3D which is a cross-sectional view taken along line C-C′ of FIG. 3A, the third antenna module 365 may be disposed to face the side surface member of the housing 310. The antenna array of the third antenna module 365 may be disposed so that a portion (e.g., a dipole antenna array) of the antenna array of the third antenna module 365 may emit radiation towards the second plate 330, and another portion (e.g., a patch antenna array) thereof may emit radiation through the third insulator 345.

According to an embodiment, the coordinate axes shown in the drawings of the disclosure may be used to denote the directions in which some components are oriented. Here, the coordinate axes may be the coordinate axes X, Y, and Z in a three-dimensional (3D) space. Referring to FIG. 3A, the X axis may be an axis parallel with the lengthwise direction of the electronic device 101, and the Y axis may be an axis parallel with the widthwise direction of the electronic device 101. The Z axis may be an axis parallel with the thicknesswise direction of the electronic device 101. According to an embodiment, the XY plane may be a plane parallel with the horizontal surface of the electronic device, and the YZ plane may be a surface parallel with the vertical surface of the electronic device.

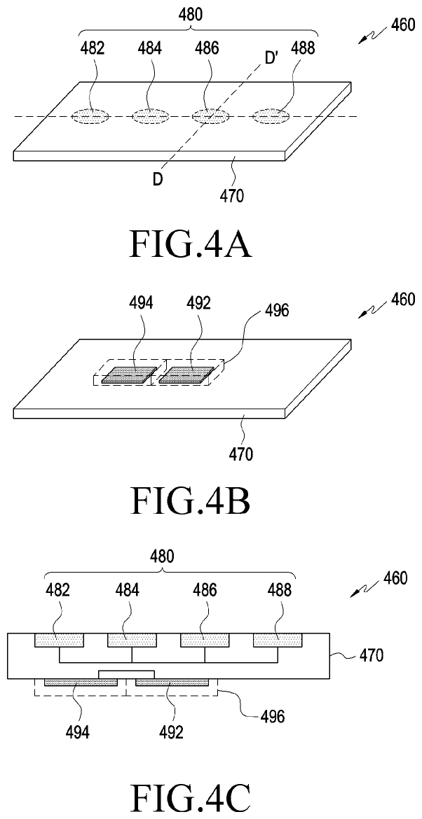

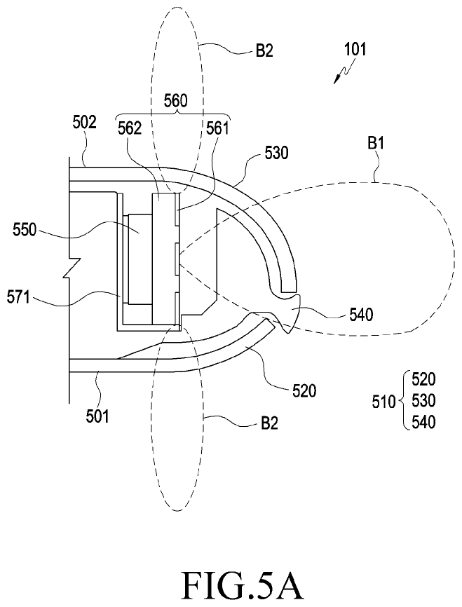

FIGS. 4A, 4B, and 4C are views illustrating an antenna module structure according to an embodiment. FIG. 4A is a perspective view of an antenna module as viewed from one side, and FIG. 4B is a perspective view of the antenna module as viewed from another side. FIG. 4C is a cross-sectional view taken along line D-D′ of the antenna module.

Referring to FIGS. 4A to 4C, according to an embodiment, an antenna module 460 may include a printed circuit board (PCB) 470, an antenna array 480, a radio frequency integrated circuit (RFIC) 492, and a power management integrated circuit (PMIC) 494. Selectively, the antenna module 460 may further include a shielding member 496. According to an embodiment, at least one of the above-mentioned components may be omitted, or at least two of the components may be integrally formed with each other.

According to an embodiment, the PCB 470 may include a plurality of conductive layers and a plurality of non-conductive layers alternately stacked with the conductive layers. Electronic components arranged on, or outside of, the PCB 470 may be electrically connected together via wires and conductive vias formed on or through the conductive layers.

According to an embodiment, the antenna array 480 may include a plurality of antenna elements 482, 484, 486, or 488 arranged to form directional beams. The antenna elements may be formed on a first surface of the PCB 470 as shown. Alternatively, the antenna array 480 may be formed inside the PCB 470. According to an embodiment, the antenna array 480 may include a plurality of antenna arrays (e.g., a dipole antenna array and/or a patch antenna array) of the same or different shapes or kinds.

According to an embodiment, the RFIC 492 may be disposed in another area (e.g., a second surface opposite to the first surface) of the PCB 470 which is spaced apart from the antenna array 480. The RFIC is configured to be able to process signals of a selected frequency band which are transmitted or received via the antenna array 480. According to an embodiment, upon transmission, the RFIC 492 may convert a baseband signal obtained from a CP (not shown) into a designated band of RF signal. Upon receipt, the RFIC 492 may transfer the RF signal received via the antenna array 480 into a baseband signal and transfer the baseband signal to the CP.

According to an embodiment, upon transmission, the RFIC 492 may up-convert an IF signal (e.g., ranging from about 9 GHz to about 11 GHz) obtained from the intermediate frequency integrated circuit (IFIC) into a selected band of RF signal. Upon receipt, the RFIC 492 may down-convert the RF signal obtained via the antenna array 480 into an IF signal and transfer the IF signal to the IFIC.

According to an embodiment, the PMIC 494 may be disposed in another partial area (e.g., the second surface) of the PCB 470 which is spaced apart from the antenna array 480. the PMIC 494 may receive a voltage from a main PCB (not shown) and provide power to various components (e.g., the RFIC 492) on the antenna assembly.

According to an embodiment, the shielding member 496 may be disposed on a portion (e.g., the second surface) of the PCB 470 to electromagnetically shield off at least one of the RFIC 492 or the PMIC 494. According to an embodiment, the shielding member 496 may include a shield can.

Although not shown, according to an embodiment, the antenna module 460 may be electrically connected with another PCB (e.g., the main PCB) via a module interface. The module interface may include a connecting member, e.g., a coaxial cable connector, board-to-board connector, interposer, or FPCB. The RFIC 492 and/or the PMIC 494 may be electrically connected with the PCB via the connecting member.

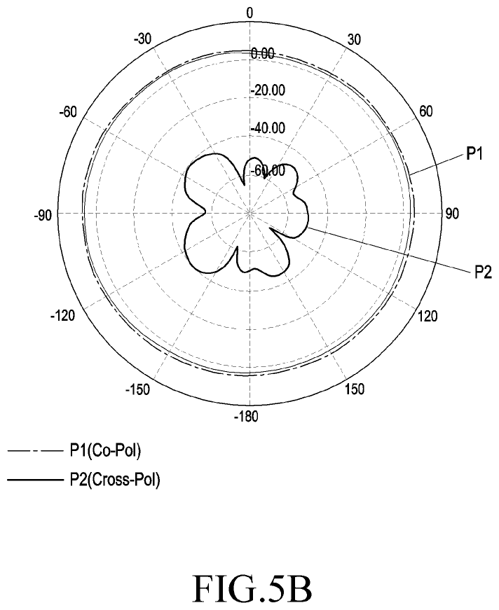

FIG. 5A is a view illustrating a range in which an antenna beam is radiated from the electronic device 101. FIG. 5B is a view illustrating a gain of antenna beam when an antenna beam is radiated from an electronic device (e.g., the electronic device 101 of FIG. 5A).

Referring to FIG. 5A, the electronic device 101 may include a housing 510 and may include at least one processor (e.g., the processor 120 of FIG. 1) and a communication module (e.g., the communication module 190 of FIG. 1) inside the housing 510. The electronic device (e.g., the electronic device 101 of FIG. 1) may include at least one antenna module 560 electrically connected with the communication module.

According to an embodiment, the housing 510 may protect other components of the electronic device 101. The housing 510 may include, e.g., a front plate 520 formed on a front surface 501 of the electronic device 101, a back plate 530 formed on a back surface 502 facing away from the front surface, and a side surface member 540 surrounding a space between the front plate and the back plate and attached to the back plate or integrally formed with the back plate. The side surface member may be formed on a side surface facing in a direction different from the front surface and the back surface. According to an embodiment, a display may be mounted on the front surface of the electronic device 101 to be visible through a significant portion of the front plate 520.

The antenna module 560 (e.g., the antenna module 460 of FIG. 4A) may include a printed circuit board 562 and at least one conductive element 561 (e.g., at least one of the antenna elements 482, 484, 486, or 488 of FIG. 4A) disposed on one surface of, or inside of, the printed circuit board (PCB) 562. According to an embodiment, the electronic device 101 may include an RFIC (and/or PMIC) 550 disposed on one surface of the printed circuit board 562. Selectively, the electronic device 101 may further include a shielding member 571. As described above in connection with FIGS. 4A to 4C, at least one of the above-mentioned components may be omitted, or at least two of the components may be integrally formed with each other in the antenna module 560. According to an embodiment, the shielding member 571 may be disposed on a portion of the PCB 562 to electromagnetically shield off the RFIC (and/or PMIC) 550. According to an embodiment, the shielding member 571 may include a shield can.

Referring to FIG. 5A, the antenna module 560 may form a beam B1 radiated to the horizontal surface (the XY plane of FIG. 3A) of the electronic device 101 (or in the vertical direction of the antenna module). The antenna module 560 may form a beam B2 radiated to the vertical surface (the YZ plane of FIG. 3A) of the electronic device 101 (or in the horizontal direction of the antenna module). According to an embodiment, among the beams radiated from the antenna module 560, the beam B1 (or broad side pattern) radiated in the vertical direction of the antenna module 560 may be a mixed beam of a horizontal component and vertical component of the beam radiated from the antenna module 560, and the beam B2 (or end fire pattern) radiated in the horizontal direction of the antenna module 560 may be a beam of any one of the horizontal or vertical component of the beam radiated from the antenna module 560. According to an embodiment, the vertical or horizontal direction of the antenna module 560 may be set based on the surface facing the side surface member 540 in the antenna module 560.

Referring to FIGS. 5A and 5B, the beams radiated from the antenna module 560 may include the beam B1 radiated in the vertical direction of the antenna module 560 and the beam B2 radiated in the horizontal direction of the antenna module 560. The beams radiated from the antenna module 560 may be strong in polarization in one direction P1 (e.g., vertical) and weak in polarization in another direction P2 (e.g., horizontal). In this case, the gain for the beam in the direction of strong polarization may be denoted as Co-Pol, and the gain for the beam in the direction of weak polarization as Cross-Pol. For example, FIG. 5B illustrates the gain of beam upon forming Co-Pol(P1) with a strong beam polarization in the vertical direction and Cross-Pol(P2) with a relatively weak beam polarization in the horizontal direction. According to an embodiment, the beam radiated from the antenna module 560 is influenced dominantly from Co-Pol(P1) as compared with Cross-Pol(P2). Thus, upon representing a beam radiated from a certain antenna module, Co-Pol alone, without Cross-Pol, may be marked.

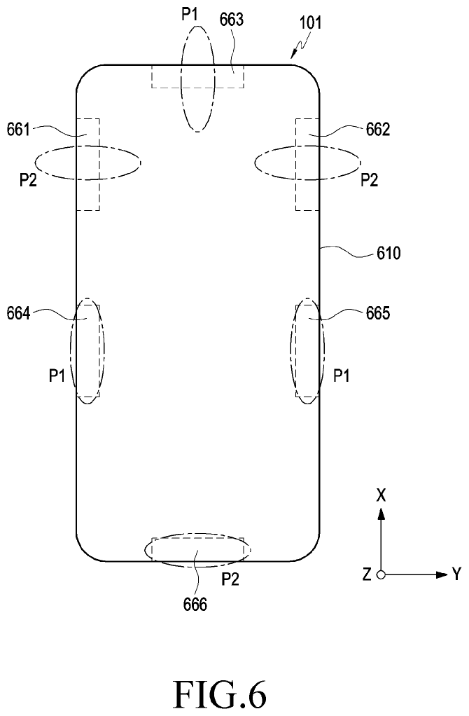

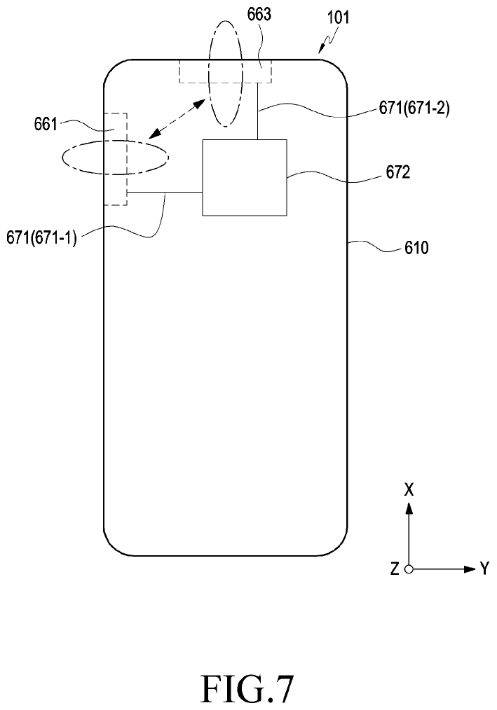

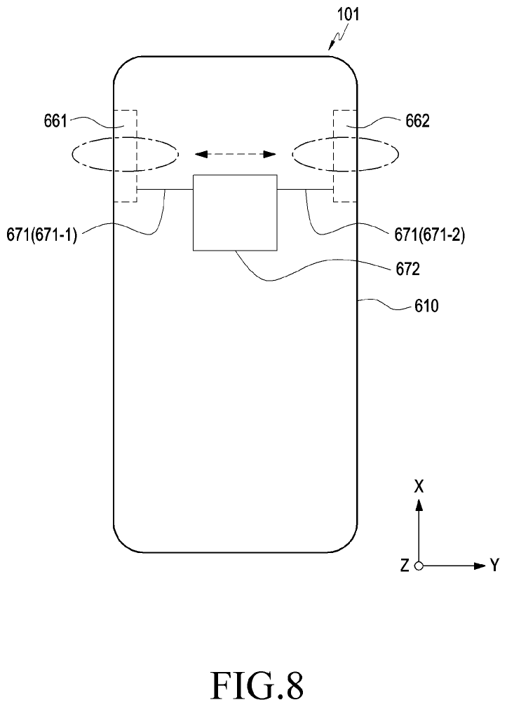

FIG. 6 is a view illustrating an electronic device 101 including a plurality of antenna modules according to an embodiment. FIG. 7 is a view illustrating an electronic device 101 including a plurality of antenna modules according to a first embodiment. FIG. 8 is a view illustrating an electronic device 101 including a plurality of antenna modules according to a second embodiment.

Referring to FIG. 6, according to an embodiment, the electronic device 101 may include a plurality of antenna modules (e.g., the antenna module 560 of FIG. 5A). The plurality of antenna modules may be disposed adjacent to the housing 610 inside the electronic device 101. As at least one antenna module is placed adjacent to the housing 610, at least a portion of the housing may be used as an antenna element, and propagation path loss may be reduced.

For example in an embodiment in which six antenna modules 661, 662, 663, 664, 665, and 666 are provided in the electronic device 101, any one antenna module (e.g., a first-first antenna module 661) may be disposed adjacent to a side surface of the electronic device 101, and another antenna module (e.g., a first-second antenna module 662) may be disposed adjacent to another side surface of the electronic device 101. Another antenna module (e.g., a first-third antenna module 663) may be disposed adjacent to the top of the electronic device 101. Further, yet another antenna module (e.g., a first-fourth antenna module 664) may be disposed adjacent to the same side surface where the first-first antenna module 661 is disposed in the electronic device 101, and still yet another antenna module (e.g., a first-fifth antenna module 665) may be disposed adjacent to the same side surface where the first-second antenna module 662 is disposed in the electronic device 101. The other antenna module (e.g., a first-sixth antenna module 666) may be disposed adjacent to the bottom of the electronic device 101. Alternatively, at least one other antenna module may be added or alternatively included, or the plurality of antenna modules may be placed in a different arrangement. The arrangement of the plurality of antenna modules may be varied depending on various functions supported in the electronic device.

Each of the plurality of antenna modules may transmit signals (or power) to the outside (e.g., an external electronic device) or receive signals (or power) from the outside. When each antenna module transmits or receives signals to/from the outside (e.g., an external electronic device), there may be various combinations of the antenna module for transmitting signals to the outside and the antenna module for receiving signals from the outside. According to an embodiment, the first-first antenna module 661 may be provided to transmit signals to the outside (e.g., an external electronic device), and the first-second antenna module 662 may be provided to receive signals from the outside (e.g., an external electronic device). According to an embodiment, the first-first antenna module 661 may be provided to receive signals from the outside (e.g., an external electronic device), and the first-second antenna module 662 may be provided to transmit signals to the outside (e.g., an external electronic device). Here, the first-first antenna module 661 and/or the first-second antenna module 662 may alternately perform signal transmission or reception depending on the environment (e.g., ambient environment or use environment) of the electronic device 101. According to an embodiment, in addition to the above-described first-first antenna module 661 and the first-second antenna module 662, the electronic device 101 may include at least one of the first-third antenna module 663, the first-fourth antenna module 664, the first-fifth antenna module 665, and/or the first-sixth antenna module 666, and whether each module transmits or receives signals may be varied according to embodiments. According to an embodiment, in the operation of one antenna module, a transmission mode or reception mode may be selected depending on the environment of the electronic device.

According to an embodiment, at least one of the first-first antenna module 661, the first-second antenna module 662, the first-third antenna module 663, the first-fourth antenna module 664, the first-fifth antenna module 665, and/or the first-sixth antenna module 666 may be connected with a conductive line 671 (e.g., 671-1 or 671-2) connected with the processor to transmit or receive signals. Although FIGS. 7 and 8 illustrate an example in which two different antenna modules are connected with one processor 672, embodiments of the disclosure are not limited thereto, and the two different antenna modules may be individually connected with two different processors.

According to an embodiment, some of the plurality of antenna modules included in the electronic device 101 may form high-polarized beams (Co-Pol) in one direction (e.g., vertical) and others may form high-polarized beams (Co-Pol) in another direction (e.g., horizontal). In the embodiment of FIG. 6, upon representing the beam radiated from the antenna module, Cross-Pol (e.g., P2 of FIG. 5B) may be omitted, with Co-Pol (e.g., P1 of FIG. 5B) alone marked.

For example, as shown in FIG. 6, the first-third antenna module 663, the first-fourth antenna module 664, and the first-fifth antenna module 665 may form high-polarized beams in one direction (e.g., vertical), and the first-first antenna module 661, the first-second antenna module 662, and the first-sixth antenna module 666 may form high-polarized beams in another direction (e.g., horizontal). According to an embodiment, the beams may be generated when the electronic device transmits/receives signals with the outside (e.g., an external electronic device) or a base station. As such, if the electronic device is operated with the plurality of antenna modules mounted therein, interference may occur between the beams radiated from adjacent antenna modules, deteriorating radiation performance.

Referring to FIG. 7, the electronic device 101 may include the first-first antenna module 661 and may include the first-second antenna module 662 as an essential component. According to an embodiment, the first-first antenna module 661 may be connected with the processor 672 via a conductive line 671 (e.g., a first conductive line 671-1), and the first-second antenna module 662 may be connected with the processor 672 via the conductive line 671 (e.g., a second conductive line 671-2). According to an embodiment, the first-first antenna module 661 may transmit or receive a signal (or power) to the outside according to an instruction applied from the processor 672. The first-second antenna module 662 may receive or transmit a signal (or power) from/to the outside according to an instruction applied from the processor 672. The respective major polarizations of beams radiated from the first-first antenna module 661 and the first-second antenna module 662 may have the same direction. Since the first-first antenna module 661 and first-second antenna module 662 have the same beam radiation direction, no interference may occur between the beams, and the radiation performance may be close to that shown in the design specifications of the antenna modules.

In contrast, if the electronic device 101 includes the first-first antenna module 661 and, as an essential component, includes the first-third antenna module 663 as shown in FIG. 8, the respective major polarizations of beam patterns radiated from the first-first antenna module 661 and the first-third antenna module 663 may be orthogonal to each other. According to an embodiment, the first-first antenna module 661 may be connected with the processor 672 via a conductive line 671 (e.g., a first conductive line 671-1), and the first-second antenna module 662 may be connected with the processor 672 via the conductive line 671 (e.g., a second conductive line 671-2). According to an embodiment, the first-first antenna module 661 may transmit or receive a signal or power to the outside according to an instruction applied from the processor 672. The first-third antenna module 663 may receive or transmit a signal (or power) from/to the outside according to an instruction applied from the processor 672. In this case, since the radiation directions of beam patterns from the first-first antenna module 661 and the first-third antenna module 663 are orthogonal to each other, inter-beam interference occurs, influencing the radiation performance of the antenna modules.

There are provided various embodiments to prevent deterioration of radiation performance due to interference when two different antenna modules have different directions of polarization as shown in FIG. 8.

According to an embodiment, among the plurality of antenna modules included in the electronic device 101, two antenna modules with different directions of polarization may be denoted, e.g., a first antenna module and a second antenna module.

The first antenna module may be an antenna module (e.g., the first-first antenna module 661 of FIG. 8) disposed adjacent to at least one surface of the housing and formed to face in one direction of the housing. The second antenna module may be an antenna module (e.g., the first-third antenna module 663 of FIG. 8) disposed apart from the first antenna module and formed to face in a direction different from the direction of the first antenna module. According to an embodiment, the second antenna module (e.g., the first-third antenna module 663 of FIG. 6) may be disposed adjacent to a surface of the housing different from the surface where the first antenna module (e.g., the first-first antenna module 661 of FIG. 8) is formed. However, embodiments of the disclosure are not limited thereto. For example, according to an embodiment, the second antenna module (e.g., the first-first antenna module 661 of FIG. 6) may be disposed adjacent to the same surface of the housing where the first antenna module (e.g., the first-first antenna module 661 of FIG. 8) is disposed.

According to an embodiment, the first antenna module (e.g., the first-first antenna module 661 of FIG. 8) and the second antenna module (e.g., the first-third antenna module 663 of FIG. 8) may be connected with at least one conductive line 671. The conductive line connected with the antenna modules may correspond to a line for transmitting or receiving signals (or power). According to an embodiment, although one antenna module may perform both transmission and reception, propagation loss may increase. According to an embodiment, the electronic device may be designed to perform only one of transmission or reception on one antenna module in a specific use environment. According to an embodiment, the first antenna module (e.g., the first-first antenna module 661 of FIG. 8) may be connected with the conductive line 671 to perform transmission, and the second antenna module (e.g., the first-third antenna module 663 of FIG. 8) may be connected with the conductive line 671 to perform reception. In contrast, alternatively, the first antenna module (e.g., the first-first antenna module 661 of FIG. 8) may perform reception, and the second antenna module (e.g., the first-third antenna module 663 of FIG. 8) may perform transmission.

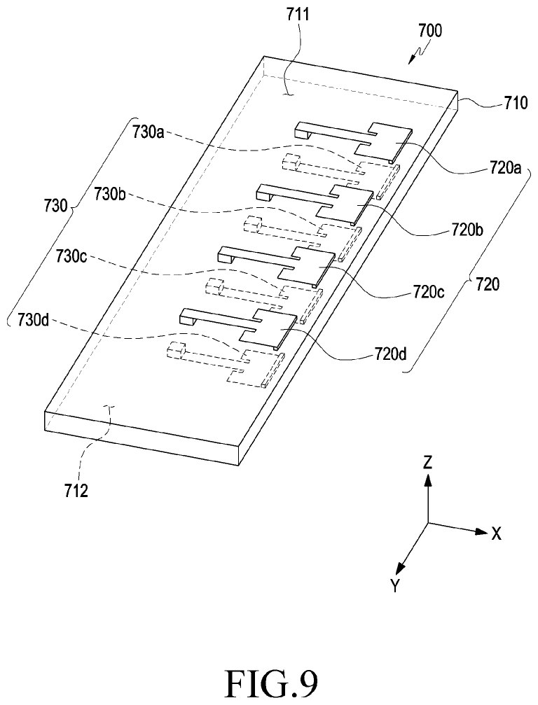

Various embodiments for preventing deterioration of radiation performance in an electronic device including a plurality of antenna modules 700 as described above are described below with reference to FIGS. 9 to 14.

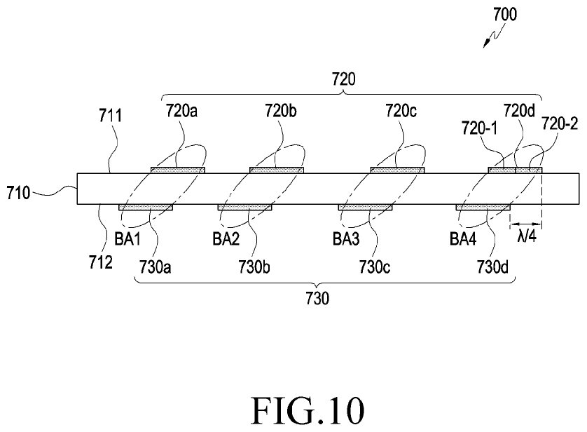

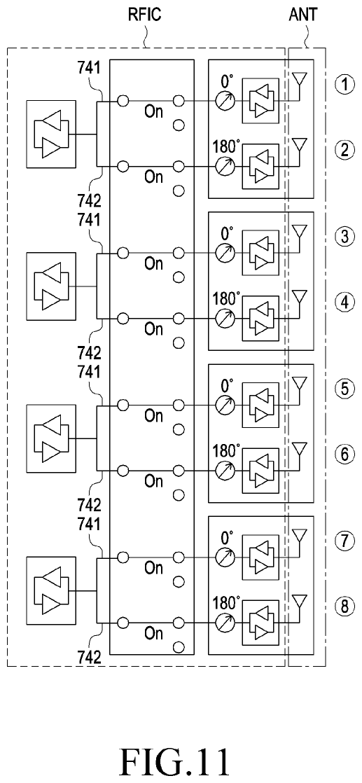

FIG. 9 is a perspective view illustrating an antenna module 700 including a plurality of first conductive elements 720 formed on one surface 711 of a base unit 710 and a plurality of second conductive elements 730 formed on another surface 712 of the base unit according to an embodiment. FIG. 10 is a cross-sectional view illustrating an antenna module 700 including a plurality of first conductive elements 720 formed on one surface 711 of a base unit 710 and a plurality of second conductive elements 730 formed on another surface 712 of the base unit according to an embodiment. FIG. 11 is a view illustrating circuit configurations applying a designated frequency of signal to a plurality of first conductive elements 720 formed on one surface 711 of a base unit 710 and a plurality of second conductive elements 730 formed on another surface 712 of the base unit 710 according to an embodiment.

According to an embodiment, the antenna module 700 may include a base unit 710 including a dielectric material, a plurality of first conductive elements 720 arranged on one surface 711 of the base unit 710, and a plurality of second conductive element 730 arranged on another surface 712 facing away from the surface 711 of the base unit 710 and corresponding to the plurality of first conductive elements 720.

According to an embodiment, the plurality of conductive elements included in the antenna module 700 may be in the form of an antenna including patches or dipoles according to various embodiments.

The plurality of second conductive elements 730 corresponding to the plurality of first conductive elements 720 may mean that the number of the plurality of first conductive elements 720 may be the same as the number of the plurality of second conductive elements 730 and that the second conductive elements 730 may be arranged in positions corresponding to the positions in which the first conductive elements 720 are formed.

Although in the embodiment of FIGS. 9 and 10, four first conductive elements 720a, 720b, 720c, and 720d and four second conductive elements 730a, 730b, 730c, and 730d are aligned in parallel with each other along the same direction, this is merely an example, and embodiments of the disclosure are not limited thereto. The shape of the conductive elements 720 and 730 is not limited to those shown in the drawings. According to an embodiment, other various shapes of conductive elements may be applied to the antenna module than those shown in the drawings.

According to an embodiment, when viewed from above the base unit 710, first portions 720-1 of the first conductive elements 720 may be disposed to overlap the second conductive elements 730, and second portions 720-2 of the first conductive elements 720 may be disposed not to overlap the second conductive elements 730, as shown in FIG. 10. According to an embodiment, in the antenna module 700, the first conductive elements 720 may at least partially, but not fully, overlap the second conductive elements 730, unaligned. The non-overlapping portion (e.g., the second portion 720-2 of the first conductive element) between the first conductive element and the second conductive element may be formed with a width of λ/4, where the wavelength of signal applied from the signal line is λ, to exert the optimal antenna array performance. In other words, the first conductive element and the second conductive element may be about λ/4 shifted therebetween as compared with when they are matched.

FIG. 11 illustrates circuit configurations for the plurality of first conductive elements 720 and the plurality of second conductive elements 730 in the antenna module 700 according to an embodiment. The plurality of first conductive elements 720 may individually correspond to the circuit configurations denoted with reference numbers \textcircled{1}, \textcircled{3}, \textcircled{5}, and \textcircled{7}, and the plurality of second conductive elements 730 may individually correspond to the circuit configurations denoted with reference numbers \textcircled{2}, \textcircled{4}, \textcircled{6}, and \textcircled{8}.

According to an embodiment, the antenna module 700 may be connected with at least one processor (e.g., the processor 120 of FIG. 1) included in the electronic device 101 and a memory (e.g., the memory 130 of FIG. 1) operatively (or electrically) connected with the processor. The memory may store instructions that, when executed, enable the processor to allow signals with a phase difference of 180 degrees to be applied to the first conductive element 720 and the second conductive element 730.

According to an embodiment, each of the first conductive elements 720a, 720b, 720c, and 720d may be connected with a first signal line 741, and each of the second conductive elements 730a, 730b, 730c, and 730d may be connected with a second signal line 742. The first signal line 741 and the second signal line 742 may be included in the above-described conductive lines 671 (e.g., the first conductive line 671-1 or the second conductive line 672-1).

According to an embodiment, the first signal line 741 and the second signal line 742 may be at least partially included in the RFIC. The plurality of first conductive elements 720a, 720b, 720c, and 720d may be rendered to support various frequency bands according to a signal transferred via at least one first signal line 741, and the plurality of second conductive elements 730a, 730b, 730c, and 730d may be rendered to support various frequency bands according to a signal transferred via at least one second signal line 742. According to an embodiment, the plurality of first conductive elements 720a, 720b, 720c, and 720d may receive an off signal or on signal using the first signal line 741, and the plurality of second conductive elements 730a, 730b, 730c, and 730d may receive an off signal or on signal using the second signal line 742.

If the antenna module 700 is configured as shown in FIGS. 9 to 11 and a signal is applied, a variation in electric field (E-field) may be caused between the plurality of first conductive elements 720 formed on one surface of the base unit 710 in the antenna module 700 and the plurality of second conductive elements 730, thus varying the radiation direction of beam from the antenna module 700. For example, if the beam radiation direction is varied by the above method, it is possible to effectively prevent deterioration of radiation performance due to interference between two different antenna modules.

According to an embodiment, the plurality of first conductive elements 720 may include a first-first conductive element 720a, a first-second conductive element 720b, a first-third conductive element 720c, and a first-fourth conductive element 720d. The plurality of second conductive elements 730 may include a second-first conductive element 730a, a second-second conductive element 730b, a second-third conductive element 730c, and a second-fourth conductive element 730d.

For example, any one (e.g., the first-first conductive element 720a) of the plurality of first conductive elements 720 and the second-first conductive element 730a corresponding to the first-first conductive element 720a may have the circuit configurations denoted with reference numbers \textcircled{1} and \textcircled{2}, respectively, as shown in FIG. 11. The processor (e.g., the processor 120 of FIG. 1) may apply signals with a phase difference of 180 degrees to the first conductive element 720 and the second conductive element 730a. An RF signal may be transmitted, with the phase varied, in the state of the signals applied to the first conductive element 720a and the second conductive element 730a remaining at the phase difference of 180 degrees by the processor. If the RF signal is transmitted, a flow of E-Field may be formed from \textcircled{1} to \textcircled{2}.

As described above, if the RF signal is transmitted with a phase difference of 180 degrees given, e.g., the first conductive element 720a and the second conductive element 730a may form beams tilted by the flow of E-Field form \textcircled{1} to \textcircled{2} since they are arranged unaligned as viewed from above the top (e.g., the surface 711 of FIG. 9) of the base unit 710, as described above in connection with FIGS. 9 to 11.

Likewise, signals with a phase difference of 180 degrees may be applied to the other first conductive elements 720b, 720c, and 720d and the other second conductive elements 730b, 730c, and 730d corresponding to the first conductive elements 720b, 720c, and 720d and, as the applied signals are varied in phase, beams BA1, BA2, BA3, and BA4 whose slopes have been tilted may be formed.

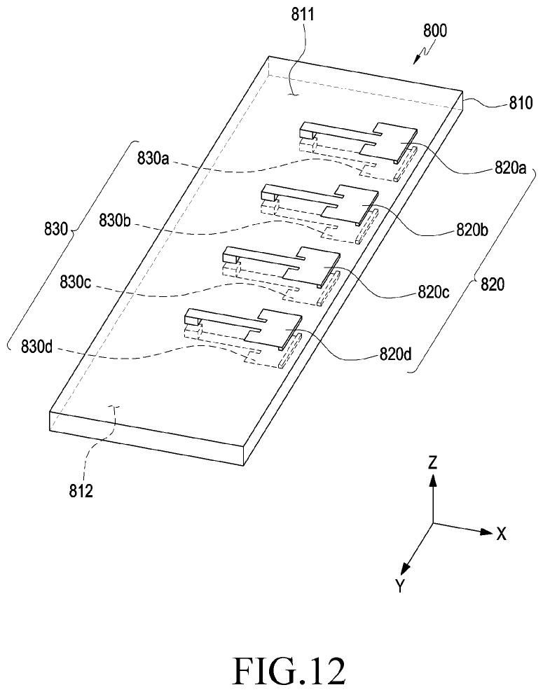

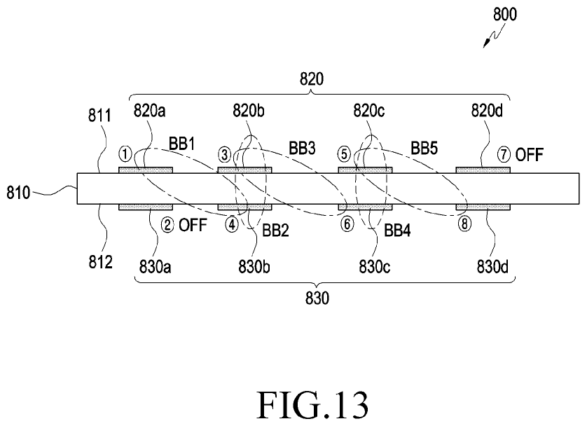

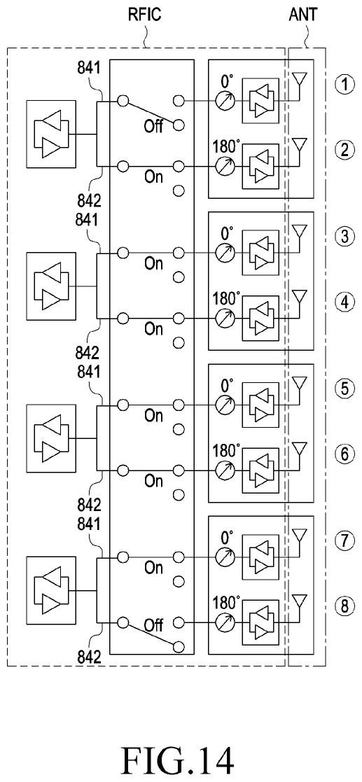

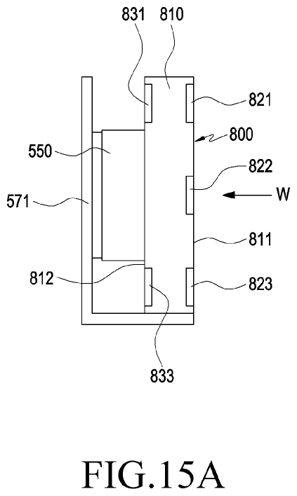

FIG. 12 is a perspective view illustrating an antenna module 800 including a plurality of first conductive elements 820 formed on one surface 811 of a base unit 810 and a plurality of second conductive elements 830 formed on another surface 812 of the base unit 810 according to another embodiment. FIG. 13 is a cross-sectional view illustrating an antenna module 800 including a plurality of first conductive elements 820 formed on one surface 811 of a base unit 810 and a plurality of second conductive elements 830 formed on another surface 812 of the base unit according to an embodiment. FIG. 14 is a view illustrating circuit configurations applying a designated frequency of signal to a plurality of first conductive elements 820 formed on one surface 811 of a base unit 810 and a plurality of second conductive elements 830 formed on another surface 812 of the base unit 810 according to an embodiment.

According to an embodiment, the antenna module 800 may include a base unit 810 including a dielectric material, a plurality of first conductive elements 820 arranged on one surface 811 of the base unit 810, and a plurality of second conductive element 830 arranged on another surface 812 facing away from the surface 811 of the base unit 810 and corresponding to the plurality of first conductive elements 820. According to an embodiment, the plurality of first conductive elements 820 may include a first-first conductive element 820a, a first-second conductive element 820b, a first-third conductive element 820c, and a first-fourth conductive element 820d. The plurality of second conductive elements 830 may include a second-first conductive element 830a, a second-second conductive element 830b, a second-third conductive element 830c, and a second-fourth conductive element 830d.

According to an embodiment, the plurality of conductive elements included in the antenna module 800 may be in the form of an antenna including patches or dipoles according to various embodiments.

Although four first conductive elements 820 and four second conductive elements 830 are aligned in parallel with each other along the same direction, this is merely an example, and embodiments of the disclosure are not limited thereto.

According to an embodiment, when viewed from above the base unit 810, the plurality of first conductive elements 820 may be formed to overlap the plurality of second conductive elements 830 as shown in FIG. 13.

FIG. 14 illustrates circuit configurations for the plurality of first conductive elements 820 and the plurality of second conductive elements 830 in the antenna module 800 according to an embodiment. The plurality of first conductive elements 820 may individually correspond to the circuit configurations denoted with reference numbers \textcircled{1}, \textcircled{3}, \textcircled{5}, and \textcircled{7}, and the plurality of second conductive elements 830 may individually correspond to the circuit configurations denoted with reference numbers \textcircled{2}, \textcircled{4}, \textcircled{6}, and \textcircled{8}.

According to an embodiment, the antenna module 800 may be connected with at least one processor (e.g., the processor 120 of FIG. 1) included in the electronic device 101 and a memory (e.g., the memory 130 of FIG. 1) operatively connected with the processor. The memory may store instructions that, when executed, enable the processor to allow signals with a phase difference of 180 degrees to be applied to the first conductive element 820 and the second conductive element 830.

According to an embodiment, each of the first conductive elements 820a, 820b, 820c, and 820d may be connected with a first signal line 841, and each of the second conductive elements 830a, 830b, 830c, and 830d may be connected with a second signal line 842. The first signal line 841 and the second signal line 842 may be included in the above-described conductive lines 671 (e.g., the first conductive line 671-1 or the second conductive line 672-1).

According to an embodiment, the first signal line 841 and the second signal line 842 may be at least partially included in the RFIC. The plurality of first conductive elements 820a, 820b, 820c, and 820d may be rendered to support various frequency bands according to a signal transferred via at least one first signal line 841, and the plurality of second conductive elements 830a, 830b, 830c, and 830d may be rendered to support various frequency bands according to a signal transferred via at least one second signal line 842. According to an embodiment, the plurality of first conductive elements 820a, 820b, 820c, and 820d may receive an off signal or on signal using the first signal line 841, and the plurality of second conductive elements 830a, 830b, 830c, and 830d may receive an off signal or on signal using the second signal line 842.

The embodiment of FIGS. 12 to 14 differs from the embodiment of FIGS. 9 to 11 in that in the embodiment of FIGS. 12 to 14, the plurality of first conductive elements 820 overlap the plurality of second conductive elements 830 and in that processor operations differ according to instructions stored in the memory.

Referring to FIG. 14, the memory (e.g., the memory 130 of FIG. 1) may store instructions that, when executed, enable the processor (e.g., the processor 120 of FIG. 1) to apply on signals to some of the plurality of first conductive elements 820 and an off signal to at least one designated other element via the transmission signal or reception signal lines. The memory may store instructions that, when executed, enable the processor (e.g., the processor 120 of FIG. 1) to apply on signals to some of the plurality of second conductive elements 830 and an off signal to at least one designated other element via the transmission signal or reception signal lines.

According to an embodiment, the processor operating the antenna module 800 may enable an off signal to be applied to the second conductive element corresponding to the first conductive element to which an on signal is applied among the plurality of first conductive elements 820, among the plurality of second conductive elements 830. The processor may apply an off signal to any one of the plurality of first conductive elements 820 and an on signal to the second conductive element corresponding thereto.

For example, any one (e.g., 820a) of the first conductive elements 820 and the second conductive element 830a corresponding to the first conductive element 820a may have the circuit configurations denoted with reference numbers \textcircled{1} and \textcircled{2}, respectively, and the processor (e.g., the processor 120 of FIG. 1) may be configured to apply signals with a phase difference of 180 degrees to the first conductive element 820a and the second conductive element 830a. Likewise, signals with a phase difference of 180 degrees may be applied to the other first conductive elements 820b, 820c, and 820d and the other second conductive elements 830b, 830c, and 830d corresponding thereto.

For example, of the signals applied to the first-first conductive element 820a and its corresponding second-first conductive element 830a, the signal applied to the second-first conductive element 830a may be turned off and the signal applied to the first-first conductive element 820a may be turned on by the processor. If an RF signal is transmitted, with the phase varied, in the state of a phase difference of 180 degrees being maintained between the first-first conductive element 820a and the second-first conductive element 830a, the existing flows of E-Field occur from \textcircled{3} to \textcircled{4} and from \textcircled{5} to \textcircled{6} while causing additional flows of E-Field from \textcircled{1} to \textcircled{4}, from \textcircled{3} to \textcircled{6}, and from \textcircled{5} to \textcircled{8}.

According to an embodiment, the processor operating the antenna module 800 may apply an off signal to the first conductive element \textcircled{1} positioned at an end of the plurality of first conductive elements 820 and an off signal to the second conductive element \textcircled{8} positioned at an end opposite to the end of the first conductive element to which the off signal has been applied among the plurality of second conductive elements 830.

As set forth above, if RF signals are transmitted with a phase difference of 180 degrees given, a beam BB2 may be formed between the first-second conductive element 820b and the second-second conductive element 830b, which overlap each other, and a beam BB4 may be formed between the first-third conductive element 820c and the second-third conductive element 830c, which overlap each other, as shown in FIGS. 12 to 14. According to an embodiment, a tilted beam BB1 may be formed between the first-first conductive element 820a and the second-second conductive element 830b, and a tilted beam BB3 may be formed between the first-second conductive element 820b and the second-third conductive element 830c. A tilted beam BB5 may be formed between the first-third conductive element 820c and the second-fourth conductive element 830d.

If the antenna module 800 is configured as shown in FIGS. 12 to 14 and a signal is applied, then, as a result similar to the embodiment of FIGS. 9 to 12, a variation in electric field (E-field) may be caused between the first conductive elements 820 formed on one surface of the base unit 810 in the antenna module 800 and the second conductive elements 830, thus varying the radiation direction of a beam from the antenna module 800. For example, the radiation direction varied in such a manner may effectively prevent deterioration of radiation performance due to interference between two different antenna modules.

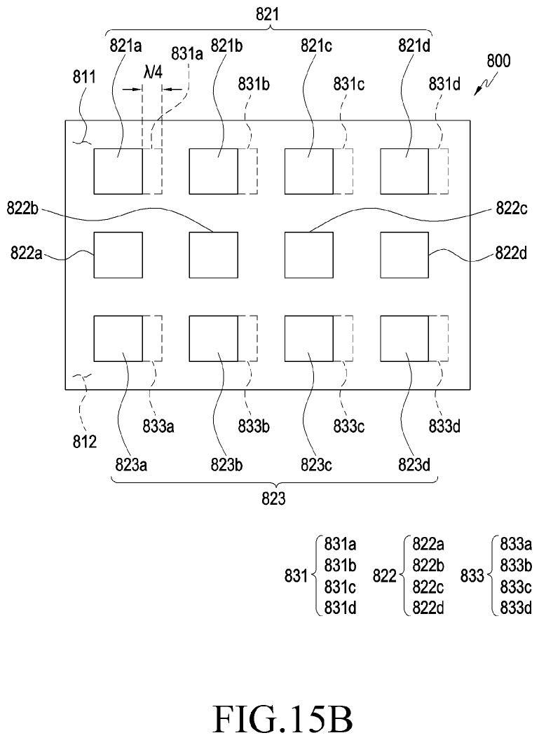

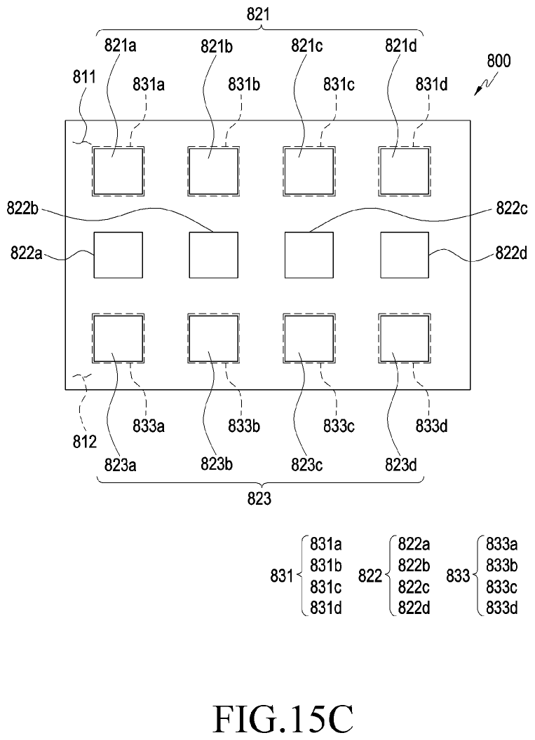

FIG. 15A is a view illustrating an antenna module 800 including a plurality of antenna assemblies according to an embodiment. FIG. 15B is a view illustrating an antenna module 800 including a plurality of antenna assemblies as viewed in direction W of FIG. 15A, according to an embodiment. FIG. 15C is a view illustrating an antenna module 800 including a plurality of antenna assemblies as viewed in direction W of FIG. 15A, according to an embodiment different from that of FIG. 15B.

Referring to FIGS. 15A to 15C, according to an embodiment, in an electronic device (e.g., the electronic device 101 of FIG. 5A), at least one of the first antenna module (e.g., the first-first antenna module 661 of FIG. 6) or the second antenna module (e.g., the first-third antenna module 663 of FIG. 6) may include a first antenna array 821, a second antenna array 822, and a third antenna array 823. For example, the first antenna array 821 may include a plurality of first conductive elements (hereinafter, a ‘plurality of first-first conductive elements 821a, 821b, 821c, and 821d’) arranged on one surface 811 of the base unit 810, and the second antenna array 822 may include another plurality of first conductive elements (hereinafter, a ‘plurality of first-second conductive elements 822a, 822b, 822c, and 822d’) along a direction parallel with the direction in which the plurality of first-first conductive elements 821a, 821b, 821c, and 821d included in the first antenna array 821 are arranged. The third antenna array 823 may include another plurality of first conductive elements (hereinafter, a ‘plurality of first-third conductive elements 823a, 823b, 823c, and 823d’) along a direction parallel with the direction in which the plurality of first conductive elements included in the first antenna array are arranged. For example, the first antenna array 821 and the third antenna array 823 each may form an end fire beam in a direction parallel with the base unit 810, and the second antenna array 822 may form a broad side beam in a direction perpendicular to the base unit 810.

According to an embodiment, at least one of the first antenna array 821, the second antenna array 822, or the third antenna array 823 may further include a plurality of second conductive elements (e.g., 831a, 831b, 831c, and 831d) on another surface 812 of the base unit 810.

For example, as shown in FIGS. 15B and 15C, a plurality of second conductive elements (hereinafter, a ‘plurality of second-first conductive elements 831a, 831b, 831c, and 831d’) corresponding to the plurality of first-first conductive elements 821a, 821b, 821c, and 821d may be formed on the other surface 812 (or back surface) of the base unit 810, where the first antenna array 821 is formed.

As another example, as shown in FIGS. 15B and 15C, another plurality of second conductive elements (hereinafter, a ‘plurality of second-third conductive elements 833a, 833b, 833c, and 833d’) corresponding to the plurality of first-third conductive elements 823a, 823b, 823c, and 823d may be formed on the other surface 812 (or back surface) of the base unit 810, where the third antenna array 823 is formed.

FIG. 15B illustrates an embodiment in which the plurality of second-first conductive elements 831a, 831b, 831c, and 831d and the plurality of second-third conductive elements 833a, 833b, 833c, and 833d are arranged unaligned with the corresponding first-first conductive elements 821a, 821b, 821c, and 821d and first-third conductive elements 823a, 823b, 823c, and 823d, respectively. The description of the circuit configurations and signal application methods according to the embodiment of FIGS. 9 to 11 may apply to the embodiment of FIG. 15B.

FIG. 15C illustrates an embodiment in which the plurality of second-first conductive elements 831a, 831b, 831c, and 831d and the plurality of second-third conductive elements 833a, 833b, 833c, and 833d are arranged to overlap the corresponding first-first conductive elements 821a, 821b, 821c, and 821d and first-third conductive elements 823a, 823b, 823c, and 823d, respectively. The description of the circuit configurations and signal application methods according to the embodiment of FIGS. 12 to 14 may apply to the embodiment of FIG. 15C.

In the embodiment of FIG. 15B or 15C, the antenna module 800 may tilt the beam, enabling adjustment of the Co-Pol and Cross-Pol components of the beam and thus reducing the deviation between the Co-Pol component and the Cross-Pol component. This may enhance the performance of beam from the antenna module.

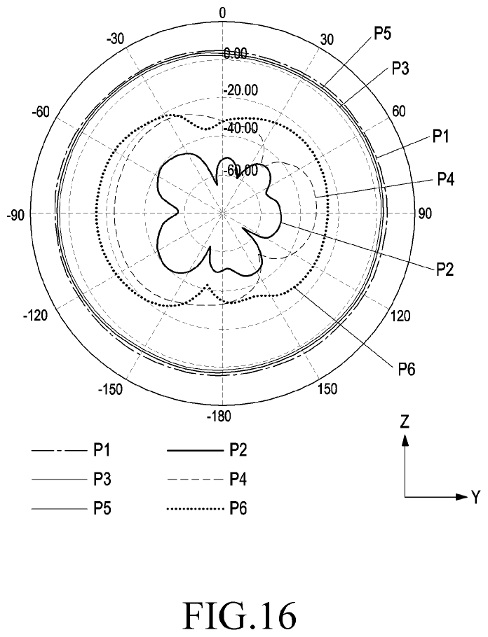

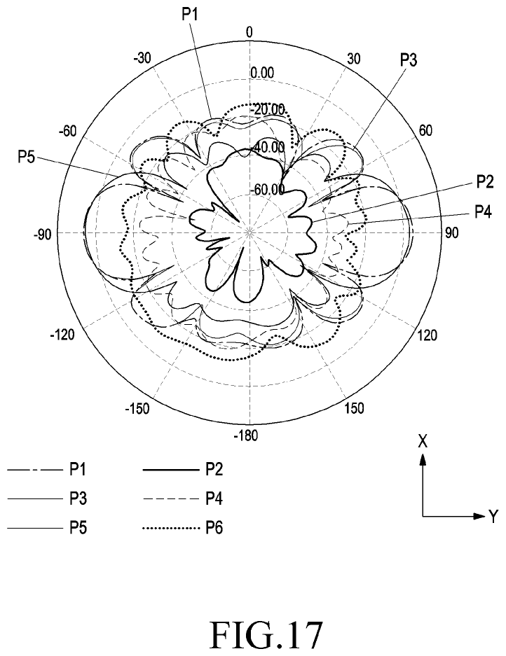

FIG. 16 is a view illustrating a gain of a first direction component of a beam pattern when an antenna beam is radiated from an electronic device according to an embodiment. FIG. 17 is a view illustrating a gain of a second direction component of a beam pattern when an antenna beam is radiated from an electronic device according to an embodiment.

The first direction component and the second direction component may be perpendicular to each other.

Referring to FIG. 16, beams radiated from an antenna module which does not meet the embodiments of FIGS. 9 to 15C may include a beam of a Co-Pol(P1) component highly polarized in one direction (e.g., vertical) and a beam of a Cross-Pol(P2) component relatively low-polarized in another direction (e.g., horizontal). According to an embodiment, beams radiated from an antenna module which meets the embodiments of FIGS. 9 to 11 and 15B may include a beam of a Co-Pol(P3) component highly polarized in one direction (e.g., vertical) and a beam of a Cross-Pol(P4) component relatively low-polarized in another direction (e.g., horizontal). According to an embodiment, beams radiated from an antenna module which meets the embodiments of FIGS. 12 to 14 and 15C may include a beam of a Co-Pol(P5) component highly polarized in one direction (e.g., vertical) and a beam of a Cross-Pol(P6) component relatively low-polarized in another direction (e.g., horizontal). It may be identified from FIG. 16 that, as compared with the beams radiated from the antenna module meeting none of the embodiments of FIGS. 9 to 15C, beams radiated from the antenna module meeting the embodiment of FIGS. 9 to 11 and 15B or the embodiment of FIGS. 12 to 14 and 15C have a prominently enhanced gain of Cross-Pol.

FIG. 17 illustrates a graph of gain of an antenna module as detected in a direction different from that of FIG. 16. Although the antenna module gain is detected in a different direction, it may be identified from FIG. 16 that, as compared with the beams radiated from the antenna module meeting none of the embodiments of FIGS. 9 to 15C, beams radiated from the antenna module meeting the embodiment of FIGS. 9 to 11 and 15B or the embodiment of FIGS. 12 to 14 and 15C have a prominently enhanced gain of Cross-Pol.

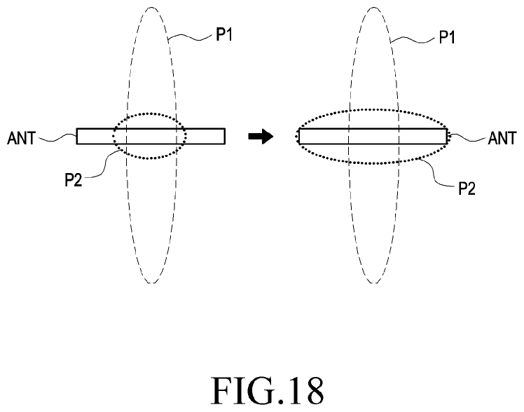

FIG. 18 is a view illustrating variations in gain of a beam pattern when an antenna beam is radiated from an electronic device, according to an embodiment.

FIG. 18 schematically illustrates the Co-Pol component (P1) and Cross-Pol component (P2) of a beam from an antenna module meeting none of the embodiments of FIGS. 9 to 15C, on the left side, and the Co-Pol component (P1) and Cross-Pol component (P2) of a beam from an antenna module meeting the embodiment of FIGS. 9 to 15C, on the right side.

Referring to FIGS. 16 to 18, the beam radiated from the antenna module according to the embodiment of FIGS. 9 to 15C may form a beam with a reduced difference between the Co-Pol and Cross-Pol components. According to such embodiments, although two different antenna modules are mounted in positions where their polarizations are orthogonal to each other in the electronic device, propagation loss may be significantly reduced.

According to an embodiment, when a proximity sensor or gesture sensor of the electronic device (e.g., the electronic device 101 of FIG. 1) is operated, the processor (e.g., the processor 120 of FIG. 1) may apply a first frequency of signal via the at least one first signal line and a second frequency of signal via the at least one second signal line.

According to an embodiment, an electronic device (e.g., the electronic device 101 of FIG. 5A) comprises a housing (e.g., the housing 510 of FIG. 5A) including a front surface (e.g., the front surface 501 of FIG. 5A), a back surface (e.g., the back surface 502 of FIG. 5A) facing away from the front surface, and a side surface disposed between the front surface and the back surface to form a space between the front surface and the back surface, a first antenna module (e.g., the first-first antenna module 661 of FIG. 6) disposed adjacent to at least a surface of the housing, facing in a direction, outside of the housing, and operated in a transmission mode for transmitting a signal to an external electronic device or in a reception mode for receiving a signal from the external electronic device, and a second antenna module (e.g., the first-third antenna module 663 of FIG. 6) disposed apart from the first antenna module, facing in a direction different from the direction of the first antenna module, operated in a reception mode for receiving a signal when the first antenna module is operated in the transmission mode, and operated in a transmission mode for transmitting a signal when the first antenna module is operated in the reception mode, wherein at least one of the first antenna module and the second antenna module includes a base unit (e.g., the base unit 710 of FIG. 10 or the base unit 810 of FIG. 13) including a dielectric material, a plurality of first conductive elements (e.g., the plurality of first conductive elements 720 of FIG. 10 or the plurality of first conductive elements 820 of FIG. 13) arranged on a first surface of the base unit, and a plurality of second conductive elements (e.g., the plurality of second conductive elements 730 of FIG. 10 or the plurality of second conductive elements 830 of FIG. 13) arranged on another surface facing away from the first surface of the base unit and corresponding to the plurality of first conductive elements.

According to an embodiment, when viewed from above the base unit, a first portion (e.g., the first portion 720-1 of FIG. 10) of the first conductive elements (e.g., the plurality of first conductive elements 720 of FIG. 10) may be disposed to overlap the second conductive elements (e.g., the plurality of second conductive elements 730 of FIG. 10), and a second portion (e.g., the second portion 720-2 of FIG. 10) of the first conductive elements may be disposed not to overlap the second conductive elements.

According to an embodiment, an electronic device comprises at least one processor (e.g., the processor 120 of FIG. 1) and a memory (e.g., the memory 130 of FIG. 1) operatively connected with the processor, wherein the memory stores instructions executed to enable the processor to apply an off signal to apply an on signal to a plurality of first conductive elements (e.g., the plurality of first conductive elements 720 of FIG. 10) via at least one first signal line (e.g., the first signal line 741 of FIG. 11) and an on signal to a plurality of second conductive elements (e.g., the plurality of second conductive elements 730 of FIG. 10) via at least one second signal line (e.g., the second signal line 742 of FIG. 11).

According to an embodiment, when a wavelength of a signal applied to the first antenna module or the second antenna module is λ, the second portion may have a width of λ/4.

According to an embodiment, when viewed from above the base unit, the first conductive elements may be disposed to overlap the second conductive elements.

According to an embodiment, the electronic device may comprise at least one processor (e.g., the processor 120 of FIG. 1) and a memory (e.g., the memory 130 of FIG. 1) operatively connected with the processor. The memory stores instructions executed to enable the processor to apply an off signal to at least one designated first conductive element among the plurality of first conductive elements and an on signal to another first conductive element among the plurality of first conductive elements via at least one first signal line (e.g., the first signal line 841 of FIG. 14), and apply an off signal to at least one designated second conductive element among the plurality of second conductive elements and an on signal to another second conductive element among the plurality of second conductive elements via at least one second signal line (e.g., the second signal line 842 of FIG. 14).

According to an embodiment, the memory may store instructions executed to enable to the processor to apply an off signal to a first conductive element positioned on an end of the plurality of first conductive elements and an off signal to a second conductive element positioned on another end of the plurality of second conductive elements.

According to an embodiment, signals with a phase difference of 180 degrees may be applied to the first conductive element and the second conductive element.

According to an embodiment, a wavelength λ of a signal applied to the first antenna module or the second antenna module may form an operation frequency ranging from 2 0GHz to 300 GHz.

According to an embodiment, the first antenna module and the second antenna module may radiate beams whose direction components are perpendicular to each other.

According to an embodiment, the first antenna module (e.g., the first-first antenna module 661 of FIG. 6) may be disposed to face at least a first surface of the housing, and the second antenna module (e.g., the first-third antenna module 663 of FIG. 6) may be disposed to face another surface which faces in a direction perpendicular to the first surface.

According to an embodiment, the plurality of first conductive elements (e.g., the plurality of first conductive elements 821a, 821b, 821c, and 821d of FIG. 15B or 15C) may be arranged side-by-side in a first direction, and the plurality of second conductive elements (e.g., the plurality of second conductive elements 831a, 831b, 831c, and 831d of FIG. 15B or 15C) may be arranged side-by-side in a direction opposite to the first direction.

According to an embodiment, at least one of the first antenna module or the second antenna module may include a first antenna array (e.g., the first antenna array 821 of FIG. 15A) including a plurality of first conductive elements arranged on a first surface of the base unit, a second antenna array (e.g., the second antenna array 822 of FIG. 15A) including a plurality of first conductive elements in a direction parallel with a direction in which the plurality of first conductive elements of the first antenna array are arranged, and a third antenna array (e.g., the third antenna array 823 of FIG. 15A) including a plurality of first conductive elements in a direction parallel with a direction in which the plurality of first conductive elements of the first antenna array are arranged, and at least one of the first antenna array, the second antenna array, or the third antenna array may include a plurality of second conductive elements in a direction parallel with a direction in which a plurality of first conductive elements are arranged, on another surface of the base unit.

According to an embodiment, the first antenna array and the third antenna array each may form a horizontal radiation (end fire) beam in a direction parallel with the base unit, and the second antenna array may form a vertical radiation (broad side) beam in a direction perpendicular to the base unit.

According to an embodiment, there is provided a method of operating an electronic device (e.g., the electronic device 101 of FIG. 5A) including a plurality of antenna modules. The electronic device includes a first antenna module (e.g., the first-first antenna module 661 of FIG. 6) disposed adjacent to at least one surface of a housing of the electronic device and facing in a first direction, outside of the housing, a second antenna module (e.g., the first-third antenna module 663 of FIG. 6) disposed apart from the first antenna module and facing in a direction different from the first direction of the first antenna module, at least one first conductive line (e.g., the first conductive line 671-1 of FIG. 6) connected with the first antenna module, and at least one second conductive line (e.g., the second conductive line 671-2 of FIG. 6) connected with the second antenna module. At least one of the first antenna module and the second antenna module includes a base unit (e.g., the base unit 710 of FIG. 10 or the base unit 810 of FIG. 13) including a dielectric material, a plurality of first conductive elements (e.g., the first conductive elements 720a, 720b, 720c, and 720d of FIG. 10 or the first conductive elements 820a, 820b, 820c, and 820d of FIG. 13) arranged on a first surface (e.g., the surface 711 of FIG. 10 or the surface 811 of FIG. 13) of the base unit, a plurality of second conductive elements (e.g., the second conductive elements 740a, 730b, 730c, and 730d of FIG. 10 or the second conductive elements 830a, 830b, 830c, and 830d of FIG. 13) arranged on a second surface (e.g., the surface 712 of FIG. 10 or the surface 812 of FIG. 13) of the base unit, which face away from the first surface of the base unit, and corresponding to the plurality of first conductive elements, at least one processor (e.g., the processor 120 of FIG. 1), and a memory (e.g., the memory 130 of FIG. 1) operatively connected with the processor. At least one first signal line (e.g., the first signal line 741 of FIG. 11 or the first signal line 841 of FIG. 14) is included in one of the first conductive line or the second conductive line and connected with the first conductive elements, and at least one second signal line (e.g., the second signal line 742 of FIG. 11 or the second signal line 842 of FIG. 14) is connected with the second conductive elements. The processor is configured to, by instructions stored in the memory, apply a first frequency of signal to the first conductive elements via the at least one first signal line and apply a second frequency of signal with a phase difference of 180 degrees from the first frequency to the second conductive elements via the at least one second signal line.

According to an embodiment, if, when viewed from above the base unit, a first portion of the first conductive elements may be disposed to overlap the second conductive elements, and a second portion of the first conductive elements may be disposed not to overlap the second conductive elements. The processor may be configured to apply an on signal to the first conductive elements and the second conductive elements via the at least one first signal line and the at least one second signal line to form a beam tilted with respect to a horizontal direction of the base unit.

According to an embodiment, the processor may be configured to apply an off signal to at least one designated first conductive element among the plurality of first conductive elements and an on signal to another first conductive element among the plurality of first conductive elements via the at least one first signal line, and apply an off signal to at least one designated second conductive element among the plurality of second conductive elements and an on signal to another second conductive element among the plurality of second conductive elements via the at least one second signal line.

According to an embodiment, a wavelength λ of a signal applied to the at least one first signal line or the at least one second signal line may be a wavelength forming an operation frequency ranging from 20 GHz to 300 GHz.

According to an embodiment, when the first antenna module and the second antenna module radiate beams whose direction components are perpendicular to each other, the processor may be configured to apply a first frequency of signal via the at least one first signal line and a second frequency of signal via the at least one second signal line.

According to an embodiment, when the first antenna module is disposed to face at least a first surface of the housing, and the second antenna module is disposed to face another surface which faces in a direction perpendicular to the first surface, and the second antenna module is operated in a reception mode for receiving a signal when the first antenna module is operated in a transmission mode, or the second antenna module is operated in the transmission mode for transmitting a signal when the first antenna module is operated in the reception mode, the processor may be configured to apply the first frequency of signal to the first conductive elements via the at least one first signal line and the second frequency of signal to the second conductive elements via the at least one second signal line.

According to an embodiment, when a proximity sensor or gesture sensor of the electronic device is operated, the processor may be configured to apply the first frequency of signal to the first conductive elements via the at least one first signal line and the second frequency of signal to the second conductive elements via the at least one second signal line.

As is apparent from the foregoing description, according to various embodiments, an electronic device including a plurality of antenna modules may cause a variation in electric field between a plurality of conductive elements included in the antenna modules, thereby forming an antenna beam tilted from the base unit of the antenna module.

According to various embodiments, an electronic device including a plurality of antenna modules may prevent deterioration of radiation performance of the antenna modules in orthogonal polarizations when the plurality of antenna modules constitute the transmit end and receive end and form directional beams.

While the disclosure has been shown and described with reference to example embodiments thereof, it will be apparent to those of ordinary skill in the art that various changes in form and detail may be made thereto without departing from the spirit and scope of the disclosure as defined by the following claims.

Although the present disclosure has been described with various embodiments, various changes and modifications may be suggested to one skilled in the art. It is intended that the present disclosure encompass such changes and modifications as fall within the scope of the appended claims.

What is claimed is:

1. An electronic device, comprising:
a housing including a front surface, a back surface facing away from the front surface, and a side surface disposed between the front surface and the back surface to form a space between the front surface and the back surface;
a first antenna module disposed adjacent to at least a surface of the housing, facing in a direction outside of the housing, and operated in a transmission mode for transmitting a signal to an external electronic device or in a reception mode for receiving a signal from the external electronic device; and
a second antenna module disposed apart from the first antenna module, facing in a direction different from the direction of the first antenna module, operated in a reception mode for receiving a signal when the first antenna module is operated in the transmission mode, and operated in a transmission mode for transmitting a signal when the first antenna module is operated in the reception mode,
wherein at least one of the first antenna module or the second antenna module includes:
a base unit including a dielectric material,
a plurality of first conductive elements arranged on a first surface of the base unit, and
a plurality of second conductive elements arranged on another surface facing away from the first surface of the base unit and corresponding to the plurality of first conductive elements.

2. The electronic device of claim 1, wherein, when viewed from above the base unit:
a first portion of the plurality of first conductive elements is disposed to overlap the plurality of second conductive elements, and
a second portion of the plurality of first conductive elements is disposed not to overlap the plurality of second conductive elements.

3. The electronic device of claim 2, wherein, when a wavelength of a signal applied to the first antenna module or the second antenna module is λ, the second portion has a width of λ/4.

4. The electronic device of claim 1, further comprising:
a processor; and
a memory operatively connected with the processor and storing instructions that, when executed by the processor, cause the processor to:
apply an off signal to at least one designated first conductive element among the plurality of first conductive elements and an on signal to another first conductive element among the plurality of first conductive elements using at least one first signal line, and
apply the off signal to at least one designated second conductive element among the plurality of second conductive elements and the on signal to another second conductive element among the plurality of second conductive elements using at least one second signal line.

5. The electronic device of claim 4, wherein, when viewed from above the base unit, the plurality of first conductive elements is disposed to overlap the plurality of second conductive elements.

6. The electronic device of claim 4, wherein the memory stores instructions that, when executed by the processor, cause the processor to apply the off signal to a first conductive element positioned on an end of the plurality of first conductive elements and the off signal to a second conductive element positioned on another end of the plurality of second conductive elements.

7. The electronic device of claim 1, wherein signals with a phase difference of 180 degrees are applied to the plurality of first conductive elements and the plurality of second conductive elements.

8. The electronic device of claim 1, wherein a wavelength λ of a signal applied to the first antenna module or the second antenna module forms an operation frequency ranging from 20 GHz to 300 GHz.

9. The electronic device of claim 1, wherein the first antenna module and the second antenna module radiate beams whose direction components are perpendicular to each other.

10. The electronic device of claim 1, wherein the first antenna module is disposed to face at least a first surface of the housing, and the second antenna module is disposed to face another surface which faces in a direction perpendicular to the first surface.

11. The electronic device of claim 1, wherein the plurality of first conductive elements are arranged side-by-side in a first direction, and the plurality of second conductive elements are arranged side-by-side in a direction opposite to the first direction.

12. The electronic device of claim 1, wherein:
at least one of the first antenna module or the second antenna module includes:
a first antenna array including a plurality of first conductive elements arranged on a first surface of the base unit,
a second antenna array including a plurality of first conductive elements in a direction parallel with a direction in which the plurality of first conductive elements of the first antenna array are arranged, and
a third antenna array including a plurality of first conductive elements in a direction parallel with a direction in which the plurality of first conductive elements of the first antenna array are arranged, and
at least one of the first antenna array, the second antenna array, or the third antenna array includes a plurality of second conductive elements in a direction parallel with a direction in which a plurality of first conductive elements are arranged on another surface of the base unit.

13. The electronic device of claim 12, wherein:
the first antenna array and the third antenna array each form a horizontal radiation beam in a direction parallel with the base unit, and
the second antenna array forms a vertical radiation beam in a direction perpendicular to the base unit.

14. A method of operating an electronic device including a plurality of antenna modules, the method comprising:
applying a first frequency of signal to a plurality of first conductive elements via at least one first signal line; and
applying a second frequency of signal with a phase difference of 180 degrees from the first frequency to a plurality of second conductive elements via at least one second signal line, wherein:
the electronic device includes:
a first antenna module disposed adjacent to at least one surface of a housing of the electronic device and facing in a first direction, outside of the housing,
a second antenna module disposed apart from the first antenna module and facing in a direction different from the first direction of the first antenna module,
at least one first conductive line connected with the first antenna module, and
at least one second conductive line connected with the second antenna module, at least one of the first antenna module or the second antenna module includes:
a base unit including a dielectric material,
the plurality of first conductive elements arranged on a first surface of the base unit,
the plurality of second conductive elements arranged on a second surface of the base unit, which face away from the first surface of the base unit, and corresponding to the plurality of first conductive elements,
a processor, and
a memory operatively connected with the processor,
the at least one first signal line included in one of the first conductive line or the second conductive line and connected with the plurality of first conductive elements, and
the at least one second signal line included in one of the first conductive line or the second conductive line and connected with the plurality of second conductive elements.

15. The method of claim 14, wherein:
when viewed from above the base unit, a first portion of the plurality of first conductive elements is disposed to overlap the plurality of second conductive elements, and
a second portion of the plurality of first conductive elements is disposed not to overlap the plurality of second conductive elements,
the method further comprises applying, by the processor executing instructions stored in the memory, an on signal to the plurality of first conductive elements and the plurality of second conductive elements via the at least one first signal line and the at least one second signal line to form a beam tilted with respect to a horizontal direction of the base unit.

16. The method of claim 14, comprising:
applying, by the processor executing instructions stored in the memory, an off signal to at least one designated first conductive element among the plurality of first conductive elements and an on signal to another first conductive element among the plurality of first conductive elements via the at least one first signal line; and
applying, by the processor executing instructions stored in the memory, the off signal to at least one designated second conductive element among the plurality of second conductive elements and the on signal to another second conductive element among the plurality of second conductive elements via the at least one second signal line.

17. The method of claim 14, wherein a wavelength λ of a signal applied to the at least one first signal line or the at least one second signal line is a wavelength forming an operation frequency ranging from 20 GHz to 300 GHz.

18. The method of claim 14, further comprising, based on the first antenna module and the second antenna module radiating beams whose direction components are perpendicular to each other, applying, by the processor executing instructions stored in the memory, a first frequency of signal via the at least one first signal line and a second frequency of signal via the at least one second signal line.

19. The method of claim 14, further comprising, based on the first antenna module being disposed to face at least a first surface of the housing, the second antenna module being disposed to face another surface which faces in a direction perpendicular to the first surface, and the second antenna module being operated in a reception mode for receiving a signal based on the first antenna module being operated in a transmission mode or the second antenna module being operated in the transmission mode for transmitting a signal when the first antenna module is operated in the reception mode:
applying, by the processor executing instructions stored in the memory, the first frequency of signal to the plurality of first conductive elements using the at least one first signal line, and
applying, by the processor executing instructions stored in the memory, the second frequency of signal to the plurality of second conductive elements using the at least one second signal line.

20. The method of claim 14, further comprising, based on a proximity sensor or gesture sensor of the electronic device being operated:
applying the first frequency of signal to the plurality of first conductive elements via the at least one first signal line, and
applying the second frequency of signal to the plurality of second conductive elements via the at least one second signal line.
